(19) United States
(12) Patent Application Publication
(10) Pub. No.: US 2011/0229672 A1
(43) Pub. Date: Sep. 22, 2011

(54) Hydrolysis-resistant polyamide-elastomer mixtures, molded articles produced therefrom and their use

(76) Inventors: Botho Hoffmann, Domat/Ems (CH); Georg Stöppelmann, Domat/Ems (CH); Werner Obrecht, Moers (DE); Thomas Früh, Mutterstadt (DE); Robert Hans Schuster, Hannover (DE); Clara Antonia Rozin, Eislingen (DE)

(21) Appl. No.: 12/866,599

(22) PCT Filed: Feb. 6, 2009
(86) PCT No.: PCT/EP09/51398

§ 371 Date: May 18, 2011

(30) Foreign Application Priority Data
Feb. 8, 2008 (DE) 10 2008 008 098.5
Sep. 25, 2008 (DE) 10 2008 042 368.8

(51) Int. Cl. B32B 1/08; C08L 77/00; C08K 3/10

(52) U.S. Cl. 428/36.91; 524/514; 524/436; 428/36.9

(57) ABSTRACT

The invention relates to polyamide-elastomer mixtures with an improved hydrolysis resistance. In this case, the elastomer is present in particular in the form of a microgel. The polyamide-elastomer mixtures according to the invention can be processed into molded articles that are used, for example, in the automobile industry, in particular as media-conducting conduits.

The invention relates to polyamide-elastomer mixtures with an improved hydrolysis resistance. In this case, the elastomer is present in particular in the form of a microgel. The polyamide-elastomer mixtures according to the invention can be processed into molded articles that are used, for example, in the automobile industry, in particular as media-conducting conduits.

Materials having moderate to high flexibility are required for producing media-conducting conduits in the automobile industry. Flexible polymers that do not contain any softeners can basically be prepared in various ways.

A first method for making polyamide flexible is based on the incorporation of polyether or polyester segments.

A second variant is based on a compounding method in which polyamides are adjusted so as to be flexible by adding ethylene/propylene or ethylene/butylene copolymers.

Both variants, that is, both the polymerization method as well as the compounding method, are disadvantageous in that the products have a reduced chemical resistance and exhibit increased swelling in fuels and oils. Moreover, these products have the drawback of poor hydrolysis resistance at increased temperatures.

Another method utilizes the flexibilizing effect of cross-linked elastomeric phases. For example, DE 103 45 043 A1 describes compositions of a thermoplastic material and microgels that have not been cross-linked by high-energy radiation and which exhibit low swelling in oil. The microgel used herein is separately produced, i.e. also cross-linked, prior to mixing. Cross-linking is carried out either directly during polymerization by selecting suitable monomers, of after polymerization using peroxides.

Based thereon, it was the object of the present invention to provide polyamide-based materials that have good flexibility and at the same time also good properties with regard to hydrolysis resistance and oil swelling.

This object is achieved with the polyamide-elastomer mixture having the features of claim 1 and the molded articles produced therefrom having the features of claim 25. The other dependent claims illustrate advantageous embodiments. Uses according to the invention are specified in claims 32, 33 and 34.

According to the invention, a polyamide-elastomer mixture is provided which contains:
a) 30 to 95% by wt. of at least one partially crystalline polyamide having a solution viscosity greater than or equal to 1.75 (measured in m-cresol solution, 0.5% by wt., 20° C.),
b) 5 to 50% by wt. of at least one elastomer prepared by emulsion polymerization and subsequent spray drying of the latex obtained during emulsion polymerization,
c) optionally, 0 to 20% by wt. of one or more polyamides having a solution viscosity of less than 1.75 (measured in m-cresol solution, 0.5% by wt., 20° C.),
   with the above-mentioned indications of % by wt. relating to the total amount of the components (a) to (c),
   and, relative to 100 parts by wt. of the components (a) to (c), from 0 to 100 parts by weight of one or more additives.

The elastomer b) produced by spray drying the latex obtained during emulsion polymerization preferably has a mean particle diameter in the range of from 2 μm to 300 μm, preferably from 2 μm to 200 μm, in particular in the range of from 5 to 150 μm. The mean particle diameter can in this case be determined, for example, from the particle size distribution as a d₅₀ value determined by laser diffraction, in particular also in the latex, for example using a Mastersizer 2000. Particularly preferably the diameters of all particles are within the range of from 2 μm to 300 μm, preferably from 2 μm to 200 μm, in particular in the range of from 5 to 150 μm. This can be determined, for example, by appraising an electron-microscopic image.

Surprisingly, it could be demonstrated that the polyamide-elastomer mixtures according to the invention have a high hydrolysis resistance. This could be proved by tensile test rods produced from the polyamide-elastomer mixture exhibiting a remaining elongation at break of at least 20% (relative to the initial value) in a water/glycol (60:40) mixture at 135° C. at a storage time of 500 h.

Preferably, the partially crystalline polyamide (a) is selected from the group consisting of the polyamides PA46, PA6, PA66, PA69, PA610, PA612, PA614, PA616, PA618, PA11, PA12, PA1010, PA1012, PA1212, PA MXD6, PA MXD6/MXDI, PA9T, PA10T, PA12T, PA 6T/6I, PA 6T/66, PA 6T/10T, their copolyamides and polyamide block copolymers with soft segments based on polyesters, polyethers, polysiloxanes or polyolefins, wherein the polyamide content of the polyamide block copolymers is at least 40% by wt, as well as their blends.

In particular, the partially crystalline polyamide (a) is selected from the group of lactam-containing homopolyamides PA6 and PA12 and the copolyamides PA6/12, PAX/66, PAX/69, PAX/610, PAX/612, PAX/614, PAX/618, PA6T/X, PA6T/6I/X, PA6T/66/X, wherein the lactam content of the copolyamides is at least 20% by wt. and X=6 or 12, and polyamide block copolymers with soft segments based on polyesters, polyethers, poylsiloxanes or polyolefins, wherein the lactam content of the polyamide block copolymers is at least 40% by wt, as well as their blends.

According to the invention, the polyamide-elastomer mixture contains preferably 40 to 85% by wt., particularly preferably 50 to 78% by wt. of component (a), relative to the sum of the components (a) to (c).

The term “partially crystalline” in connection with the polyamide (a) denotes, within the context of the invention, a polymer that has amorphous and crystalline areas at the same time (see, for example, Hans Batzer: “Polymere Werkstoffe in drei Bänden”, Vol. I, chapter 4, pp. 253 et seqq. and chapter 5, pp. 277 et seqq.).

The polyamide (a) preferably has a terminal amino group concentration in the range of from 20 to 120 μeq/g, preferably of from 30 to 100 μeq/g. The terminal carboxyl group concentration of the polyamide (a) is preferably maximally 30 μeq/g, particularly preferably maximally 20 μeq/g.

The polyamide (a) contained according to the invention preferably has a solution viscosity (measured in m-cresol solution, 0.5% by wt., 20° C.) in the range of from 1.75 to 2.4, in particular of from 1.8 to 2.3.

The elastomer b), which is also called a microgel, is produced by emulsion polymerization. The term “elastomer” according to the invention signifies, in particular, that this is a cross-linked, also partially cross-linked, i.e. branched polymeric material which preferably has a glass transition temperature of less than 10° C., preferably less than 0° C.

The elastomer b) is produced by emulsion polymerization, preferably of
b1) ? 55% by wt. of at least one conjugated diene,
b2) 5 to 45% by wt. acrylonitrile,
b3) optionally 0 to 5% by wt. of one or more polyfunctional radically polymerizable monomer, and
b4) optionally 0 to 20% by wt. of one or more radically polymerizable monomer different from b1) to b3),
   with the above-mentioned indications of % by wt. relating to the total amount of the components b1) to b4).

Preferably, monomers from the group consisting of butadiene, isoprene, 2-chlorobutadiene and 2,3-dichlorobutadiene are used as conjugated dienes (b1). Butadiene is particularly preferred.

In a preferred embodiment, the amount of acrylonitrile as the component b2) is in the range of from 10 to 40% by wt, particularly preferably in the range of from 28 to 40% by wt., relative to the total amount of the components b1) to b4).

The polyfunctional radically polymerizable monomer (b3) is preferably selected from monomers comprising two or more functional radically polymerizable groups, such as di- or polyunsaturated radically polymerizable monomers, in particular compounds with preferably 2, 3 or 4 polymerizable C═C double bonds, such as, in particular, diisopropenylbenzene, divinylbenzene, divinylether, divinylsulfone, diallylphthalate, triallylcyanurate, triallylisocyanurate, 1,2-polybutadiene, N,N′-m-phenylenemaleimide, 2,4-toluoylenebis(maleimide), triallyltrimellitate and polyfunctional acrylates and methacrylates of C₂- to C₁₀-polyalcohols, in particular ethylene glycol, propanediol-1,2, butanediol-1,4, hexanediol, polyethylene glycol with 2 to 20, in particular 2 to 8 oxyethylene units, neopentyl glycol, bisphenol-A, glycerin, trimethylolpropane, pentaerythritol, sorbitol with unsaturated polyesters from aliphatic di- and polyols and mixtures thereof.

More preferably, the polyfunctional radically polymerizable monomers (b3) are selected from divinylbenzene, trimethylolpropane trimethacrylate, trimethylolpropane triacrylate, ethylene glycol dimethacrylate, ethylene glycol diacrylate, butanediol-1,4-di(meth)acrylate and mixtures thereof.

The aforementioned polyfunctional radically polymerizable monomers (b3) in particular serve cross-linking during the preparation of the elastomer (b).

However, cross-linking the elastomer (b) can also be carried out without using the component b3), by emulsion polymerization of the components b1) and b2) and subsequent cross-linking in the presence of a radical initiator. Suitable radical initiators are in this case selected from organic peroxides, in particular dicumylperoxide, t-butylcumylperoxide, bis-(t-butylperoxy-isopropyl)benzene, di-t-butylperoxide, 2,5-dimethylhexane-2,5-dihydroperoxide, 2,5-dimethylhexine-3,2,5-dihydroperoxide, dibenzoylperoxide, bis-(2,4-dichlorobenzoyl)peroxide, t-butylperbenzoate as well as organic azo compounds, in particular azo-bis-isobutyronitrile and azo-bis-cyclohexanenitrile and di- and polymercapto-compounds, in particular dimercaptoethane, 1,6-dimercaptohexane, 1,3,5-trimercaptotriazine and mercapto-terminated polysulfide rubbers, in particular mercapto-terminated reaction products of bis-chloroethylformal with sodium polysulfide etc.

With regard to cross-linking subsequent to the polymerization, reference is made, in particular, to EP 1307 504.

Furthermore, cross-linking can take place during the preparation of the elastomer b) also without adding the above-mentioned polyfunctional radically polymerizable monomers b3) by continuing the polymerization to high conversion values, in particular to conversion values ≧70 mol-%, preferably ≧80 mol-%, relative to the total amount of the monomer mixture used, preferably at temperatures of ≧10° C., more preferably ≧20° C., or in the monomer feeding process by polymerization with high internal conversion values.

Another possibility also lies in carrying out the polymerization in the absence of regulators and/or at increased temperature, in particular at temperatures ≧10° C. In these conditions, the double bonds that remain in the case dienes are also used as monomers in the polymerisate (b) are also accessible for cross-linking reactions.

Optionally, the elastomer (b) used according to the invention can moreover contain 0 to 20% by wt. of the radically polymerizable monomer b4) that is different from the components b1) to b3). Preferably, the radically polymerizable monomer b4) is selected from styrene, esters of acrylic and methacrylic acid, such as ethyl(meth)acrylate, methyl(meth)acrylate, n-propyl(meth)acrylate, n-butyl(meth)acrylate, 2-ethylhexyl(meth)acrylate, as well as hydroxyl-group-containing (meth)acrylates, such as hydroxyethyl(meth)acrylate, hydroxypropyl(meth)acrylate and hydroxybutyl(meth)acrylate, tetrafluoroethylene, vinylidenefluoride, hexafluoropropene, as well as double-bond-containing carboxylic acids, in particular acrylic acid, methacrylic acid, maleic acid, fumaric acid, itaconic acid, amine functionalized (meth)acrylates, such as primary aminoalkyl(meth)acrylic acid esters, such as aminoethyl(meth)acrylate, aminopropyl(meth)acrylate and aminobutyl(meth)acrylate, secondary aminoalkyl(meth)acrylic acid esters, in particular tert-butylamino(C2-C4)alkyl(meth)acrylate, acrolein, N-vinyl-2-pyrrolidone, 2-vinyl-pyridine, 4-vinyl-pyridine, N-allyl-urea and N-allyl-thiourea, (meth)acrylamides, such as (meth)acrylamide, singly or doubly N-substituted (meth)acrylamides and mixtures thereof.

Preferably, the elastomer b) consists of nitrile rubber (NBR) and is prepared by emulsion polymerization, wherein cross-linking takes place during polymerization. At the end of the emulsion polymerization, the nitrile rubber is present in the form of cross-linked particles which are also referred to as NBR microgel.

The NBR microgels preferred according to the invention generally have repeating units of at least one α,β-unsaturated nitrile, at least one conjugated diene, and optionally of one or more further copolymerizable monomers.

The conjugated diene can be of any kind. (C₄-C₆)-conjugated dienes are preferably used. 1,3-butadiene, isoprene, 2,3-dimethylbutadiene, piperylene, 1,3-pentadiene or mixtures thereof are particularly preferred. 1,3-butadiene and isoprene or mixtures thereof are particularly preferred. 1,3-butadiene is most particularly preferred.

Any known α,β-unsaturated nitrile can be used as a α,β-unsaturated nitrile, (C₃-C₅)-α,β-unsaturated nitriles such as acrylonitrile, methacrylonitrile, 1-chloroacrylonitrile, ethacrylonitrile or mixtures thereof are preferred. Acrylonitrile is particularly preferred.

Thus, a particularly preferred nitrile rubber is a copolymer of acrylonitrile and 1,3-butadiene.

Apart from the conjugated diene and the α,β-unsaturated nitrile, one or more further copolymerizable monomers can be used, for example α,β-unsaturated mono- or dicarboxylic acids, their esters or amides.

Fumaric acid, maleic acid, acrylic acid, methacrylic acid, crotonic acid and itaconic acid can be used as α,β-unsaturated mono- or dicarboxylic acids. In this case, maleic acid, acrylic acid, methacrylic acid and itaconic acid are preferred. Such nitrile rubbers are commonly also referred to as carboxylated nitrile rubber, or abbreviated “XNBR”.

Alkyl esters, alkoxyalkyl esters, hydroxyalkyl esters or mixtures thereof are used as the esters of the α,β-unsaturated carboxylic acids.

Particularly preferred alkyl esters of the α,β-unsaturated carboxylic acids include methyl(meth)acrylate, ethyl(meth)acrylate, propyl(meth)acrylate, n-butyl(meth)acrylate, t-butyl(meth)acrylate, hexyl(meth)acrylate, 2-ethlyhexyl(meth)acrylate, octyl(meth)acrylate and lauryl(meth)acrylate. In particular, n-butylacrylate is used.

Particularly preferred alkoxyalkyl esters of the α,β-unsaturated carboxylic acids are methoxyethyl(meth)acrylate, ethoxyethyl(meth)acrylate and methoxyethyl(meth)acrylate. Methoxyethylacrylate is used in particular.

Particularly preferred hydroxyalkyl esters of the α,β-unsaturated carboxylic acids are hydroxyethyl(meth)acrylate, hydroxypropyl(meth)acrylate and Hydroxy(butyl(meth)acrylate.

Moreover, polyethylene glycol(meth)acrylate, polypropylene glycol(meth)acrylate, glycidyl(meth)acrylate, epoxy(meth)acrylate and urethane(meth)acrylate, for example, are used as esters of the α,β-unsaturated carboxylic acids.

Other possible monomers are vinyl aromatic compounds such as styrene, α-methylstyrene and vinylpyridine.

The contents of conjugated diene and α,β-unsaturated nitrile in the nitrile rubbers preferably used according to the invention may vary over large ranges. The content or the sum of the conjugated diene(s) usually is in the range of from 20 to 95% by wt., preferably in the range of from 40 to 90% by wt. particularly preferably in the range of from 60 to 85% by wt., relative to the total polymer. The content or sum of the α,β-unsaturated nitrile(s) usually is 5 to 80% by wt, preferably 10 to 60% by wt., particularly preferably 15 to 40% by wt., relative to the total polymer. The contents of the monomers in each case add up to 100% by wt.

The additional monomers can be present in amounts of 0 to 40% by wt., preferably 0.1 to 40% by wt., particularly preferably 1 to 30% by wt., relative to the total polymer. In that case, the corresponding contents of the conjugated diene(s) and/or the α,β-unsaturated nitrile(s) are replaced by the contents of these additional monomers, with the contents of all monomers still adding up in each case to 100% by wt.

If esters of (meth)acrylic acid are used as additional monomers, this is usually done in amounts of 1 to 25% by wt.

If α,β-unsaturated mono- or dicarboxylic acids are used as additional monomers, this is usually done in amounts of less than 10% by wt.

In the nitrile rubber microgels used preferably according to the invention, the nitrogen content is determined in accordance with DIN 53 625 according to Kjedahl. Because of the cross-linking, the nitrile rubber microgels are insoluble in methylethylketone at 20° C. ≧85% by wt.

The glass transition temperatures of the cross-linked nitrile rubbers or nitrile rubber microgels are usually in the range of from −70° C. to +10° C., preferably in the range of from −60° C. to 0° C.

Preferably, elastomers b) used according to the invention are nitrile rubbers which have repeating units of acrylonitrile, 1,3-butadiene and, optionally, of one or more other copolymerizable monomers. Nitrile rubbers are also preferred which have repeating units of acrylonitrile, 1,3-butadiene and of one or more α,β-unsaturated mono- or dicarboxylic acids, their esters or amides, and in particular repeating units of an alkylester of an α,β-unsaturated carboxylic acid, very particularly preferably of methyl(meth)acrylate, ethyl(meth)acrylate, propyl(meth)acrylate, n-butyl(meth)acrylate, t-butyl(meth)acrylate, hexyl(meth)acrylate, 2-ethlyhexyl(meth)acrylate, octyl(meth)acrylate or lauryl(meth)acrylate.

The preparation of the elastomers or the nitrite rubber microgels preferred as the component b) used according to the takes place by means of emulsion polymerization invention in the method according to the invention.

Emulsion polymerizations are generally carried out using emulsifiers. For this purpose, a wide range of emulsifiers is known and accessible to the person skilled in the art. Anionic emulsifiers or also neutral emulsifiers, for example, can be used as emulsifiers. Anionic emulsifiers are preferably used, particularly preferably in the form of water-soluble salts.

Modified resin acids obtained by dimerization, disproportionation, hydrogenation and modification of resin acid mixtures that contain abietic acid, neoabietic acid, palustric acid, laevopimaric acid can be used as anionic emulsifiers. A particularly preferred modified resin acid is disproportionated resin acid (Ullmann's Encyclopedia of Industrial Chemistry, 6th edition, Volume 31, pp. 345-355).

Fatty acids can also be used as anionic emulsifiers. They contain 6 to 22 C-atoms per molecule. They can be fully saturated or also contain one or more double bonds in the molecule. Examples for fatty acids include capric acid, lauric acid, myristic acid, palmitic acid, stearic acid, oleic acid, linoleic acid, linolenic acid. The carboxylic acids are usually based on origin-specific oils or fats, such as castor oil, cottonseed, peanut oil, linseed oil, coconut fat, palm kernel oil, olive oil, rape oil, soybean oil, fish oil and beef fat etc. (Ullmann's Encyclopedia of Industrial Chemistry, 6th edition, Volume 13, pp. 75-108). Preferred carboxylic acids are derived from coconut fatty acid and beef fat and are partially or fully hydrogenated.

Such carboxylic acids based on modified resin acids or fatty acids are used in the form of water-soluble lithium, sodium, potassium and ammonium salts.

The sodium and potassium salts are preferred.

Further anionic emulsifiers are sulfonates, sulfates and phosphates bonded to an organic residue. Possible organic residues include aliphatic, aromatic, alkylated, condensated aromatic compounds as well as methylene-bridged aromatic compounds, wherein the methylene-bridged and condensed aromatic compounds can be additionally alkylated. The length of the alkyl chains is 6 to 25 C-atoms. The length of the alkyl chains bonded to the aromatic compounds is between 3 and 12 C-atoms.

The sulfates, sulfonates and phosphates are used in the form of lithium, sodium, potassium and ammonium salts. The sodium, potassium and ammonium salts are preferred.

Examples for such sulfonates, sulfates and phosphates include Na-laurylsulfate, Na-alkylsulfonate, Na-alkylarylsulfonate, Na-salts of methylene-bridged arylsulfonates, Na-salts of alkylated naphthalene sulfonates as well as the Na-salts of methylene-bridged naphthalene sulfonates, which may also be oligomerized, wherein the degree of oligomerization is between 2 to 10. Usually, the alkylated naphthalene sulfonic acids and the methylene-bridged (and optionally alkylated) naphthalene sulfonic acids are present as isomer mixtures which can also contain more than 1 sulfonic acid group (2 to 3 sulfonic acid groups) within the molecule. Na-laurylsulfate, Na-alkylsulfonate mixtures with 12 to 18 C atoms, Na-alkylarylsulfonates, Na-diisobutylene naphthalenesulfonate, methylene-bridged polynaphthalenesulfonate mixtures as well as methylene-bridged arylsulfonate mixtures are particularly preferred.

Neutral emulsifiers are derived from the addition products of ethylene oxide and propelene oxide to compounds with sufficiently acid hydrogen. This includes, for example, phenol, alkylated phenol and alkylated amines. The average degrees of polymerization of the epoxides are between 2 to 20. Examples for neutral emulsifiers are ethoxylated nonylphenols with 8, 10 and 12 ethelene oxide units. The neutral emulsifiers are usually not used on their own, but in combination with anionic emulsifiers.

The Na-salts and K-salts of disproportionated abietic acid and of partially hydrogenated tallow fatty acid as well as mixtures thereof, sodium laurylsulfate, Na-alkylsulfonates, sodium alkylbenzenesulfonate, as well as alkylated and methylene-bridged naphthalene sulfonic acids are preferred.

The emulsifiers are used in an amount of 0.2 to 15 parts by wt., preferably 0.5 to 12.5 parts by wt., particularly preferably 1.0 to 10 parts by wt. relative to 100 parts by wt. of the monomer mixture.

Emulsion polymerization is generally carried out using the aforementioned emulsifiers. If, after the completion of polymerization, latices are obtained which have a tendency for premature auto-coagulation due to a certain instability, the above-mentioned emulsifiers can also be added for post-stabilization of the latices. This may become necessary in particular prior to removing non-reacted monomers by treatment with water vapor as well as prior to storage of latex or carrying out spray drying.

Molecular Weight Regulators:

Preferably, the emulsion polymerization is carried out such that, in particular, the nitrile rubber preferred according to the invention cross-links during the polymerization. The use of molecular weight regulators is therefore generally not required in this case. However, molecular weight regulators whose nature is, however, not critical may nevertheless be used. The regulator is then usually used in an amount of 0.01 to 3.5 parts by wt., preferably 0.05 to 2.5 parts by wt. relative to 100 parts by wt. of the monomer mixture. Mercaptan-containing carboxylic acids, mercaptan-containing alcohols, xanthogen disulfides, thiuram disulfides, halogenated hydrocarbons, branched aromatic or aliphatic hydrocarbons as well as linear or branched mercaptans, for example, can be used as molecular weight regulators. These compounds usually comprise 1 to 20 carbon atoms (see Rubber Chemistry and Technology (1976), 49(3), 610-49 (Uraneck, C. A.): “Molecular weight control of elastomers prepared by emulsion polymerization” and D. C. Blackley, Emulsion Polymerization, Theory and Practice, Applied Science Publishers Ltd London, 1975, pp. 329-381).

Examples for mercaptan-containing alcohols and mercaptan-containing carboxylic acids include monothioethyleneglycol and mercaptopropionic acid.

Examples for xanthogen disulfides include dimethylxanthogen disulfide, diethylxanthogen disulfide and diisopropylxanthogen disulfide.

Examples for thiuram disulfides include tetramethylthiuram disulfide, tetraethylthiuram disulfide and tetrabutylthiuram disulfide.

Examples for halogenated hydrocarbons include tetrachlorohydrocarbon, chloroform, methyl iodide, diiodomethane, difluorodiiodomethane, 1,4-diiodobutane, 1,6-diiodohexane, ethylbromide, ethyl iodide, 1,2-bibromotetrafluoroethane, bromotrifluoroethene, bromedifluoroethene.

Examples for branched hydrocarbons include those from which an H radical can easily be cleaved off. Examples for this are toluene, ethylbenzene, cumol, pentaphenylethane, triphenylmethane, 2,4-diphenyl, 4-methyl-1-pentene, dipentene as well as terpenes such as limonene, α-pinene, β-pinene, α-carotene and β-carotene.

Examples for linear or branched mercaptans include n-hexylmercaptan or also mercaptans containing 12-16 carbon atoms and at least three tertiary carbon atoms, wherein sulfur is bonded to one of these tertiary carbon atoms. These mercaptans can be used either singly or in mixtures. For example, the addition compounds of hydrogen sulfide to oligomerized propene, in particular tetrameric propene, or to oligomerized isobutene, in particular trimeric isobutene, which are frequently referred to in the literature as tertiary dodecyl mercaptan (“t-DDM”), are suitable.

Such alkylthiols or (isomer) mixtures of alkylthiols are either commercially available or can be prepared by the person skilled in the art in accordance with processes that are sufficiently described in the literature (see e.g. JP 07-316126, JP 07-316127 and JP 07-316128 as well as GB 823,823 and GB 823,824.)

The individual alkylthiols or mixtures thereof are usually used in an amount of 0.05 to 3 parts by wt., preferably of 0.1 to 1.5 parts by wt., relative to 100 parts by wt. of the monomer mixture.

Dosing of the molecular weight regulator or the mixture of molecular weight regulators is done either at the start of the polymerization or in portions during the course of the polymerization, with addition in portions of all or individual components of the regulator mixture during the polymerization being preferred.

Typically, polymerization initiators that disintegrate into radicals (radical polymerization initiators) are used for initiating emulsion polymerization. This includes compounds containing an —O—O— unit (peroxo compounds) or an —N═N— unit (azo compounds).

The peroxo compounds include hydrogen peroxide, peroxo disulfates, peroxo diphosphates, hydroperoxides, per-acids, per-acid esters, per-acid anhydrides and peroxides with two organic residues. The sodium, potassium and ammonium salts are suitable salts of peroxodisulfuric acid and peroxodiphosphoric acid. Suitable hydroperoxides include, for example, t-butylhydroperoxide, cumolhydroperoxide and p-menthanehydroperoxide. Suitable peroxides with two organic residues include dibenzoylperoxide, 2,4,-dichlorobenzoylperoxide, di-t-butylperoxide, dicumylperoxide, t-butylperbenzoate, t-butylperacetate etc. Suitable azo compounds include azobisisobutyronitrile, azobisvaleronitrile and azobiscyclohexanenitrile.

Hydrogen peroxide, hydroperoxides, per-acids, per-acid esters, peroxo disulfate and peroxo diphosphate are also used in combination with reducing agents. Suitable reducing agents include sulfenates, sulfinates, sulfoxylates, dithionite, sulfite, metabisulfite, disulfite, sugar, urea, thiourea, xanthogenates, thioxanthogenates, hydrazinium salts, amines and amine derivatives such as aniline, dimethylaniline, monoethanolamine, diethanolamine or triethanolamine. Initiator systems consisting of an oxidizing and a reducing agent are referred to as redox systems. When using redox systems, salts of transition metal compounds such as iron, cobalt, nickel are often additionally used in combination with suitable complexing agents such as sodium ethylene diamtetraacetate, sodium nitrilotriacetate and trisodiumphosphate or tetrapotassiumdiphosphate.

Preferred redox systems include, for example: 1) Potassium peroxodisulfate in combination with triethanolamine 2) ammonium peroxodiphosphate in combination with sodium metabisulfite (Na₂S₂O₅), 3) p-menthanehydroperoxide/sodium formaldehydesulfoxylate in combination with Fe-II-sulfate (FeSO₄×7 H₂O), sodium ethylenediaminoacetate and trisodiumphosphate; 4) cumolhydroperoxide/sodium formaldehydesulfoxylate in combination with Fe-II-sulfate (FeSO₄×7 H₂O), sodium ethylenediaminoacetate and tetrapotassium diphosphate.

The amount of oxidizing agent preferably is 0.001 to 1 parts by wt. relative to 100 parts by wt. monomer. The molar amount of reducing agent is between 50% to 500% relative to the molar amount of the oxidizing agent used.

The molar amount of complexing agent depends on the amount of transition metal used and is usually equimolar therewith.

For carrying out the polymerization, all or individual components of the initiator system are added to the polymerization in a dosed manner at the start of the polymerization or during the course of the polymerization.

The addition in portions of all or individual components of the activator system during the polymerization is preferred. The reaction rate can be controlled by sequential addition.

The polymerization time is generally in the range of from 5 h to 30 h and substantially depends on the acrylic nitrile content of the monomer mixture, on the activator system, and on the polymerization temperature.

The polymerization temperature is generally in the range of from 0 to 100° C., preferably in the range of from 20 to 80° C.

When conversions in the range of from 50 to 100%, preferably in the range of more than 85%, are reached, polymerization is generally stopped.

During polymerization, as many polymerization conversions as possible are aimed for in order to cross-link the nitrile rubber. For this reason, the use of stoppers can be dispensed with. If stoppers are used nevertheless, then dimethyldithiocarbamate, Na-nitrite, mixtures of dimethyldithiocarbamate and Na-nitrite, hydrazine and hydroxylamine as well as salts derived therefrom, such as hydrazinium sulfate and hydroxylammoniumsulfate, diethylhydroxylamine, diisopropylhydroxylamine, water-soluble salts of hydroquinone, sodiumdithionite, phenyl-α-naphthylamine and aromatic phenols such as tert-butylbrenzcatechol, or phenothiazine are suitable, for example.

The amount of water used in the emulsion polymerization is in the range of from 70 to 300 parts by wt., preferably in the range of from 80 to 250 parts by wt., particularly preferably in the range of from 90 to 200 parts by wt., relative to 100 parts by wt. of the monomer mixture.

Salts can be added to the aqueous phase during the emulsion polymerization for reducing viscosity during polymerization, for adjusting pH, and as pH buffers. Typical salts are salts of monovalent metals in the form of potassium and sodium hydroxide, sodium sulfate, sodium carbonate, sodium hydrogencarbonate, sodium chloride and potassium chloride. Sodium and potassium hydroxide, sodium hydrogencarbonate and potassium chloride are preferred. The amounts of these electrolytes are in the range of from 0 to 1 parts by wt., preferably 0 to 0.5 parts by wt., relative to 100 parts by wt. of the monomer mixture.

Polymerization can be carried out either discontinuously or also continuously in a series of stirred-tank reactors.

In order to achieve a uniform polymerization process, only a part of the initiator system is used for the start of the polymerization and the rest is added later in a dosed manner during the polymerization. Usually, polymerization is started with 10 to 80% by wt., preferably 30-50% by wt. of the total amount of initiator. Later addition in a dosed manner of individual components of the initiator system is also possible.

If chemically uniform products are to be produced, acrylonitrile or butadiene is added later in a dosed manner when the composition is outside of the azeotropic ratio of butadiene/acrylonitrile. Preferably, later addition is carried out in NBR types with acrylonitrile contents of 10 to 34 as well as in the types with 40 to 50% by wt. acrylonitrile (W. Hofmann, Rubber Chem, Technol. 36 (1963) 1). Later addition in a dosed manner is done—as is specified in DD 154 702—preferably in computer-controlled manner based on a computer program.

The short-stopped latex is subjected to a water vapor distillation for removing non-converted monomers and volatile components. In this case, temperatures in the range of from 70° C. to 150° C. are used, with pressure being reduced at temperatures <100° C.

Prior to the removal of the volatile components, a post-stabilization of the latex with an emulsifier can be carried out. For this purpose, the aforementioned emulsifiers are used expediently, in amounts of 0.1 to 2.5% by wt., preferably 0.5 to 2.0% by wt., relative to 100 parts by wt. nitrile rubber.

Prior to or during spray drying, one or more anti-aging agents can be added to the latex. Phenolic, aminic or other anti-aging agents are suitable for this purpose.

Suitable phenolic anti-aging agent include alkylated phenols, styrenated phenol, sterically hindered phenols, such as 2,6-di-tert-butylphenol, 2,6-di-tert-butyl-p-cresol (BHT), 2,6-di-tert-butyl-4-ethylphenol, ester-group-containing, sterically hindered phenols, thioether-containing, sterically hindered phenols, 2,2′-methylene-bis-(4-methyl-6-tert-butylphenol) (BPH) as well as sterically hindered thiobisphenols.

If a discoloration of the rubber is insignificant, aminic anti-aging agent are also used, e.g. mixtures of diaryl-p-phenylenediamines (DTPD), octylated diphenylamine (ODPA), phenyl-α-naphthylamine (PAN), phenyl-β-naphthylamine (PBN), preferably those based on phenylenediamine. Examples for phenylenediamines include N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis-1,4-(1,4-dimethylpentyl)-p-phenylenediamine (77PD) etc.

Other anti-aging agent include phosphites such as tris-(nonylphenyl)phosphite, polymerized 2,2,4-trimethyl-1,2-dihydroquinolin (TMQ), 2-mercaptobenzimidazole (MBI), methyl-2-mercaptobenzimidazol (MMBI), zinc-methyl-mercaptobenzimidazole (ZMMBI). The phosphites are generally used in combination with phenolic anti-aging agents. TMQ, MBI and MMBI are primarily used for NBR types that are peroxide-vulcanized.

The elastomers b) used according to the invention are generally elastomers or microgels that have not been cross-linked by high-energy radiation since their use could lead to problems with regard to compatibility with the polyamide matrix, and thus, to poorer mechanical properties.

The inventors surprisingly found that the polyamide-elastomer mixtures have the desired properties if the processing of the elastomer or of the microgels b) is carried out by spray drying of the latex obtained during emulsion polymerization. Spray drying of the latices generally takes place in customary spray towers. In this case, the latex, which is preferably heated to 30 to 100° C., is fed into the spray tower via pumps and sprayed through nozzles located in the head of the tower, preferably at pressures of 50 to 500 bar, preferably at 100 to 300 bar. Hot air with an inlet temperature of preferably 100 to 200° C. is supplied in the counterflow and evaporates the water. The powder sinks to the bottom and the dried powder is extracted at the base of the tower. Separating agents and other additives used optionally, such as anti-aging agents, anti-oxidants, optical brightening agents etc. are preferably blown in as dry powders, also at the head of the tower. The latices supplied to the spray tower preferably have solid concentrations of 10 to 60, more preferably 20 to 50% by wt., still more preferably 30 to 50% by wt. relative to the latex (determined in accordance with ISO 126:2005).

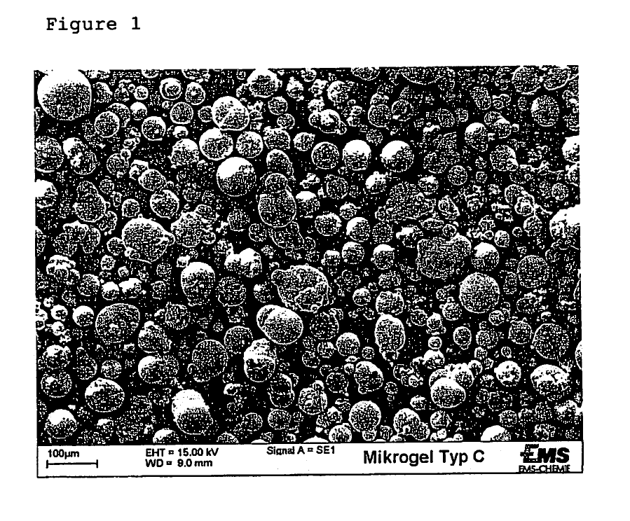

By this type of processing, spherical or almost spherical microgel particle agglomerates, in particular, are obtained, the average diameter of which preferably does not exceed 300 μm, more preferably 200 μm, still more preferably 100 μm (see, for example, FIG. 1).

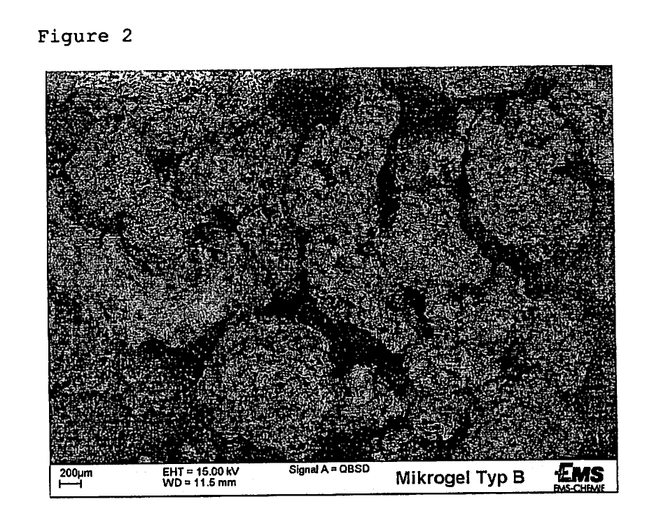

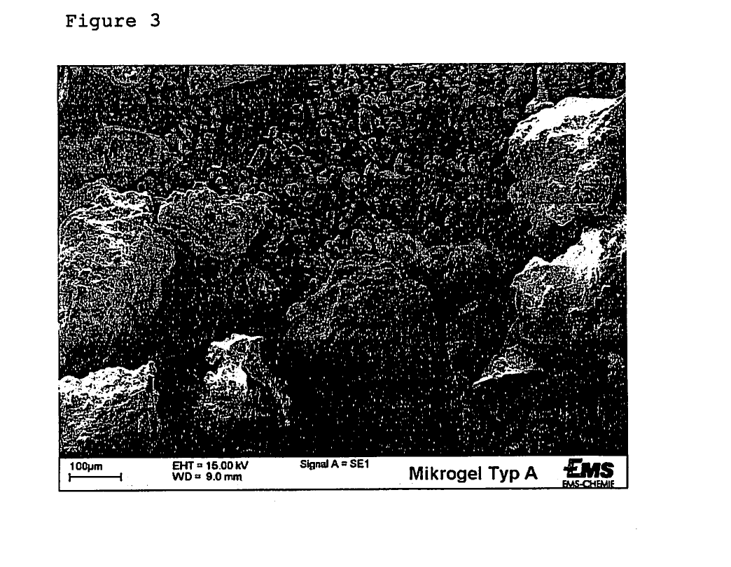

The elastomer (b) used according to the invention, which is mixed in this form with the polyamide (a) and, optionally, additionally with the polyamide (c) and, optionally, other additives, thus preferably consists of almost spherical particles which preferably have an average diameter in the range of from 2 to 300 μm, more preferably in the range of from 2 to 200 μm, still more preferably in the range of from 5 to 150, and in particular in the range of from 5 to 100 μm. Other methods of processing the microgel latices, such as, in particular, coagulation, co-coagulation with another latex polymer as well as freeze coagulation of the latices, filtration, subsequent pellet washing, drying and subsequent grinding yield comparatively coarse, irregularly shaped microgel particles with a generally much larger average diameter (see FIGS. 2 and 3).

Preferably, in processing the latex obtained during emulsion polymerization by spray drying, commercially available separating agents can also be used additionally.

Preferably, the separating agents are selected from silicic acids, in particular with a specific surface area according to BET of more than 5 m²/g, calcium carbonate, magnesium carbonate, silicates, such as talcum and mica, fatty acid salts, such as, in particular, alkaline and alkaline earth salts, such as salts of fatty acids with more than 10 carbon atoms, such as, in particular, calcium and magnesium salts of such fatty acids, such as calcium stearate, magnesium stearate and aluminum zinc stearate, calcium phosphate, aluminum oxide, barium sulfate, zinc oxide, titanium dioxide, polymers with a high glass transition temperature of, for example, more than 60° C., such as polyesters, polyolefines and starch, hydrophilic polymers, such as polyvinyl alcohol, polyalkyleneoxide compounds, in particular polyethyleneoxide compounds, such as polyethylene glycols or polyethylene glycolethers, polyacrylic acid, polyvinylpyrrolidone and cellulose derivatives, fluorocarbon polymers and mixtures of the above-mentioned separating agents.

Preferably, calcium carbonate is added as a separating agent during the processing of the elastomer latex.

However, the elastomer (b) can also be transferred into the desired advantageous form of use (spray-dried microgel) without adding a separate separating agent and thus be incorporated into the polyamide matrix.

According to the invention, the polyamide-elastomer mixture preferably contains 5 to 40% by wt., particularly preferably 10 to 30% by wt. of the elastomer (b) relative to the sum of the components (a) to (c).

In particular, both partially crystalline (as defined above) polyamides as well as amorphous or micro-crystalline polyamides can be contained as the polyamide (c).

In a preferred embodiment, the polyamide molding material, apart from the component (a), also contains up to 20% by wt., in particular up to 15% by wt., relative to the sum of the components a) to c), of at least one amorphous or micro-crystalline polyamide (component (c)) based on aliphatic, cycloaliphatic or aromatic diamines, dicarboxylic acids and/or aminocarboxylic acids, preferably with 6 to 36 carbon atoms and mixtures of such homopolyamides and/or copolyamides. In this embodiment, the molding materials preferably contain 2 to 20% by wt., in particular 3 to 15% by wt. of the component (c), relative to the sum of the components a) to c).

For the preferably amorphous or micro-crystalline polyamides (component c) and/or copolyamides used according to the invention, the following systems are preferred:

Polyamide based on aliphatic, cycloaliphatic or aromatic diamines, dicarboxylic acids, lactams and/or aminocarboxylic acids, preferably with 6 to 36 carbon atoms, or a mixture of such homopolyamides and/or copolyamides. Preferably, the cycloaliphatic diamines are MACM, IPD and/or PACM, with or without additional substituents. The aliphatic dicarboxylic acid preferably is an aliphatic dicarboxylic acid with 2 to 36, preferably 8 to 20 carbon atoms arranged linearly or branched, particularly preferably with 10, 12, 13, 14, 16 or 18 carbon atoms.

In this case, MACM stands for the ISO designation bis-(4-amino-3-methyl-cyclohexyl)-methane, which is commercially available under the trade name 3,3′-dimethyl-4-4′-diaminodicyclohexylmethane as Laromin C260 type (CAS Nr. 6864-37-5), preferably with a melting point between −10° C. and 0° C. A number, such as, for example, in MACM12, in this case signifies an aliphatic linear C12 dicarboxylic acid (DDS, dodecanedioic acid), with which the diamine MACM is polycondensated.

TPS stands for isophthalic acid, and PACM stands for the ISO designation bis-(4-amino-cyclohexyl)-methane, which is commercially available under the trade name 4,4′-diaminodicyclohexylmethane as Dicykan type (CAS Hr. 1761-71-3), preferably with a melting point between 30° C. and 45° C.

A homopolyamide selected from the group MACM12, MACM13, MACM14, MACM16, MACM18, PACM12, PACM13, PACM14, PACM16, PACM18 and/or a copolyamide selected from the group of MACM12/PACM12, MACM13/PACM13, MACM 14/PACM14, MACM16/PACM16, MACM18/PACM 18. Mixtures of such polyamides are also possible.

Polyamides based on aromatic dicarboxylic acids with 8 to 18, preferably 8 to 14 carbon atoms or a mixture of such homopolyamides and/or copolyamides, preferably based on PXDA and/or MXDA, in particular based on lactams and/or aminocarboxylic acids, wherein the aromatic dicarboxylic acids are preferably TPS, naphthalene dicarboxylic acid and/or IPS.

Polyamides selected from the group: MACM9-18, PACM9-18, MACMI/12, MACMI/MACMT, MACMI/MACMT/12, 6I6T/MACMI/MACMT/12, 3-6T, 6I6T, TMDT, 6I/MACMI/MACMT, 6I/PACMI/PACMT, 6I/6T/MACMI, MACMI/MACM36, 6I, 12/PACMI or 12/MACMT, 6/PACMT, 6/6I, 6/IPDT or mixtures thereof, wherein 50 mol % of IPS can be replaced with TPS.

The aforementioned preferably amorphous or micro-crystalline polyamides (component c) preferably have a glass transition temperature of greater than 40° C., more preferably of greater than 60° C., still more preferably of greater than 90° C., particularly preferably of greater than 110° C., in particular of greater than 130° C., and most preferably of greater than 150° C. The relative solution viscosity preferably is in the range of from 1.3 to less than 1.75 (measured in m-cresol solution, 0.5% by wt.) more preferably in the range of from 1.4 to 1.70, and in particular of from 1.5 to 1.70.

The polyamides c) preferably have a melting heat in the range of from 4 to 40 J/g, in particular in the range of from 4 to 25 J/g (determined by means of DSC), the amorphous polyamides have a melting heat of less than 4 J/g. Preferably, micro-crystalline polyamides based on the diamines MACM and PACM are used. Examples of such polyamides include the systems PA MACM9-18/PACM9-18, with PA MACM12/PACM12, with a PACM content of more than 55 mol % (relative to the total diamine amount), in particular, being used according to the invention.

The polyamide-elastomer composition according to the invention can contain from 0 to 100 parts by wt. of one or more customary additives relative to 100 parts by wt. of the components a) to c). This means that, if, for example, 0 parts by weight of the customary additives are present per 100 parts by weight of the components a) to c), then the composition generally consists of 100% by wt. of the components a) to c), or that, if, for example, 100 parts by weight of the customary additives are present per 100 parts by weight of the components a) to c), then the composition generally consists of 50% by wt. of the components a) to c).

Preferably, the polyamide-elastomer composition according to the invention consists of the components a) to c) and the customary additives which are optionally present. This means that the polyamide-elastomer composition according to the invention can, in particular, comprise from 0 to 50% by wt. of the additives and from 50 to 100% by wt. of the components a) to c), relative to the total amount of the polyamide-elastomer composition.

The optionally present additives generally are commercially available additives. They are selected, in particular, from the above-mentioned separating agents, anti-aging agents, such as anti-oxidants, and optical, brighteners, flame retardants, light stabilizers, nucleating agents, antifungal agents, antimicrobial agents, anti-hydrolysis agents etc., which are preferably added during the preparation of the component b). Furthermore, they can be customary additives, such as inorganic or organic fillers, such as, for example, glass fibers, inorganic or organic pigments, such as, for example, carbon black, or colorants, antistatic agents, antiblocking agents etc.

In principle, the aforementioned additives can be added to the polyamide-elastomer composition at any stage of its production, including the production of the individual components a) to c). Thus, as was already explained, the aforementioned separating agents are expediently added in the production of component b) during spray drying, wherein, in particular, anti-aging agents, such as antioxidants, can be added additionally.

Also, a molded article is provided according to the invention, which is obtainable from a polyamide-elastomer mixture as described above.

Such molded articles preferably have a elongation at break of at least 20%, preferably of at least 30% relative to the initial value and measured in tensile test rods in a water/glycol (60:40) mixture at 135° C. and a storage time of 500 h.

In the dry condition, the molded articles preferably have an elongation at break of at least 150%.

Moreover, the molded articles exhibit a high degree of flexibility, which is evident from a tensile modulus in ISO test rods in the dry condition in the range of from 300 to 1500 MPa.

Preferably, the molded article has a notch impact strength of at least 10 kJ/m2 at −30° C., measured with ISO test rods.

The molded article preferably exhibits oils swelling in IRM 903 according to 4d at a temperature of 125° C. of maximally 3%.

The MVR (melt volume rate), at 275° C. and a load of 21.6 kg, is preferably in the range of from 50 to 200 cm³/10 min.

The parameters specified above are determined in accordance with the methods or standards mentioned in the examples.

The polyamide-elastomer mixture according to the invention is used in particular in the production of molded articles or smooth, corrugated or partially corrugated mono- or multilayer pipes that are in contact with liquid media containing water, oil, glycol, methanol, ethanol and/or fuel. This includes, in particular, ventilation systems for crankcases, mono- and multilayer pipes in the negative as well as the positive pressure range, as well as cooling liquid pipes that are in contact with water and/or oil, or oil-conducting pipes or pipes in contact with oil in the automobile industry.

The subject matter according to the invention shall be explained in more detail with reference to the following examples and figures without limiting it to the special embodiments shown herein.

### EXAMPLE 1

In the following table 1, the compositions of a mixture according to the invention are shown in comparison with two mixtures known from the prior art (referred to as Comparative Examples 1 and 2).

TABLE 1

| | Comparative | Comparative | |
|---|---|---|---|
| | Example 1 | Example 2 | Example 1 |
| Polyamide | 70.8 | 70.8 | 70.8 |
| Type A | | | |
| Polyamide | 8 | 8 | 8 |
| Type B | | | |
| Microgel Type A | 20 | | |
| (not inventive) | | | |
| Microgel Type B | | 20 | |
| (not inventive) | | | |
| Microgel Type C | | | 20 |
| (not inventive) | | | |
| Black MB | 1.2 | 1.2 | 1.2 |
| based on PA12 | | | |

The following starting materials were used for producing the mixtures:

Polyamide Type A: Polyamide 12 with ηᵣₑₗ=2.11, NH2: 52 μeq/g, COOH: 15 μeq/g
Polyamide Type B: Polyamide 12 with ηᵣₑₗ=1.65, NH2: 105 μeq/g, COOK 10 μeq/g

Microgel Type A (not inventive): Copolymer from butadiene: 68.8%, acrylonitrile: 26.7° A), HEMA: 1.5%, TMPTMA: 3.0%, prepared according to the teaching of EP 1 152 030 A2; polymerization conversion: 99%; worked up by coagulation with aqueous calcium chloride solution, drying and subsequent grinding with separating agent calcium carbonate (added during grinding—5% by wt., relative to the total mass of microgel and separating agent) (FIG. 3).

Microgel B (not inventive) and C were produced starting from the same latex. The latex was produced by copolymerization of the monomers butadiene and acrylonitrile with the weight ratio 62/38 and 0.37 parts by wt. tert.-dodecyl mercaptan (Phillips Petroleum Corp.) without the addition of cross-linking agents and without the addition of another monomer. Polymerization was started at 30° C. by adding ammonium peroxodisulfate (0.025 parts by wt.) and triethanolamine (0.018 parts by wt.). Polymerization was carried out partially adiabatic. A post-activation was carried out with 0.018 parts by wt. ammonium peroxodisulfate at 45° C. and a polymerization conversion of 90%. Short-stopping was effected at a polymerization conversion of 97% by adding 0.08 parts by wt. diethylhydroxylamine. Following the removal of the residual monomers and other volatile constituents by water-vapor distillation, the latex had a solid content of 48.5% by wt., a pH value of 10.6, and a mean particle diameter of 198 nm; the gel content and the swelling index (in each case determined in toluene) were: 90.5% by wt. and 7.6. The glass transition temperature was −18° C. and the width of the glass transition stage 7° C. Prior to processing, 1.15% by wt. of the antioxidant Wingstay L (butylated reaction product of p-cresol with dicyclopentadiene by the company Eliokem) was added to the latex.

Microgel Type B (not inventive): worked up by coagulation with aqueous calcium chloride solution, washing, drying and subsequent grinding while adding separating agent calcium carbonate (5% by wt., relative to the total mass of microgel and separating agent) (FIG. 2).

Microgel Type C (inventive): Latex was worked up by spray drying while adding the separating agent calcium chloride (5% by wt., relative to the total mass of microgel and separating agent) (FIG. 1) (Commercially available microgel Baymod N VPKA 8641 by Lanxess Deutschland GmbH).

Polyamide (a) and (c) as well as the microgel (b) were dosed together into the feeding mechanism of a double screw extruder (ZSK 30, Coperion) and compounded at cylinder temperatures of 200 to 280° C., a screw speed of 180 r.p.m. and a throughput of 12 kg/h. The strands exiting the nozzles were cooled in a water bath and then granulated. After drying at 80° C., the molding masses were injection-molded to form molded articles and test pieces.

The molding materials were examined as follows:

MVR: (Melt volume rate) at 275° C. according to ISO 1133
SZ: impact strength and notch impact strength according to ISO 179/1 eU (Charpy) Tensile modulus, breaking strength and elongation at break were determined in accordance with ISO 527 with ISO test rods, standard ISO/CD 3167, type A1 170×20/10×4 mm at a temperature of 23° C. The mechanical quantities were determined in the dry condition.

The relative viscosity (ηᵣₑₗ) was determined at 20° C. with a 0.5% m-cresol solution according to the standard DIN EN ISO 307.

| | | Comp. | Comp. | P 12 | |
|---|---|---|---|---|---|
| | | Ex. | Ex . | (Type | |
| | | 1 | 2 | A) | Ex. 1 |
| MVR | cm³/10 min | 20 | n.m. | 27 | n.m. |
| (275° C./5 kg) | | | | | |
| MVR | cm³/10 min | 205 | 135 | n.d. | 165 |
| (275° C./21.6 kg) | | | | | |
| Elasticity modulus | Mpa | 1110 | 1130 | 1600 | 1150 |
| Tensile strength | Mpa | 39 | 41 | 45 | 45 |
| Elongation at | % | 210 | 240 | 230 | 250 |
| break | | | | | |
| Impact strength | kJ/m² | w.b. | w.b. | w.b. | w.b. |
| Charpy new, | | | | | |
| 23° C. | | | | | |
| Impact strength | kJ/m² | w.b. | w.b. | w.b. | w.b. |
| Charpy new, | | | | | |
| −30° C. | | | | | |
| Notch impact | kJ/m² | 90 | 80 | 8 | 100 |
| strength Charpy | | | | | |
| new, 23° C. | | | | | |
| Notch impact | kJ/m² | 12 | 11 | 6 | 15 |
| strength Charpy | | | | | |
| new, −30° C. | | | | | |
| Oil swelling | % by wt. | 3.6 | 2.1 | 1.1 | 1.8 |
| Half life | H | 115 | 210 | n.d. | 350 |
| (Hydrolysis test) | | | | | |

n.d.: not determined
n.m.: not measurable
w.b.: without breaking

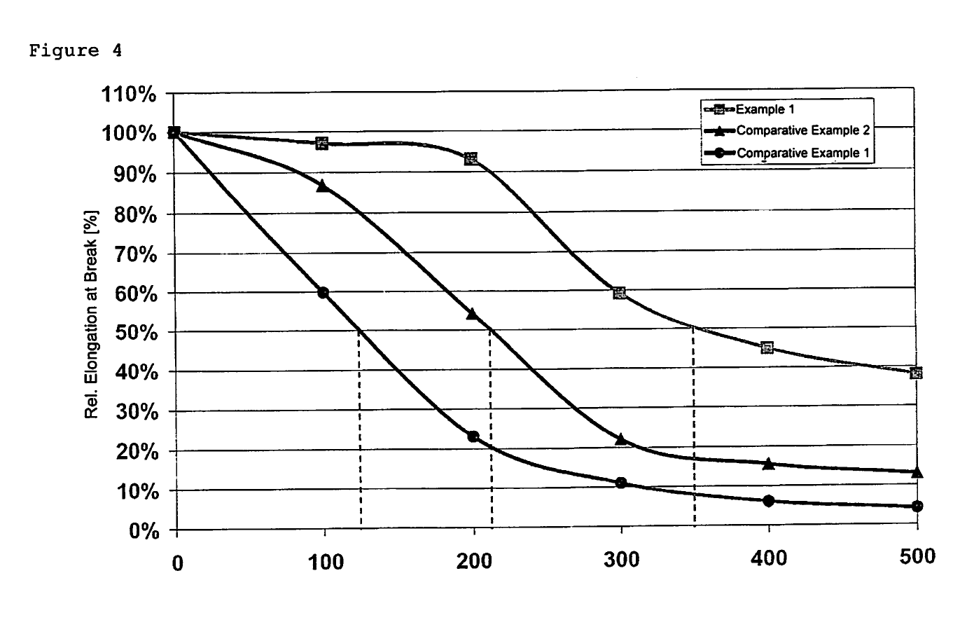

In addition, hydrolysis resistance was determined in comparison with the mixtures from the comparative examples. For this purpose, storage took place in a water-glycol mixture with a mixing ratio of 60 to 40 at 135° C. and defined storage time. The commercially available coolant additive Havoline XLC was used as a glycol. Tensile test rods with a thickness of 4 mm were used for storage. It can be seen in FIG. 4 that the mixture according to the invention has a significantly higher residual elongation at break (relative to the initial value) as compared with the mixtures known from the prior art. By using the microgel spray-dried according to the invention, the half life in the hydrolysis test could be doubled on average.

1. Polyamide-elastomer mixture, containing
a) 30 to 95% by wt. of at least one partially crystalline polyamide having a solution viscosity greater than or equal to 1.75 (measured in m-cresol solution, 0.5% by wt., 20° C.),
b) 5 to 50% by wt. of at least one elastomer prepared by emulsion polymerization and subsequent spray drying of the latex obtained during emulsion polymerization,
c) optionally, 0 to 20% by wt. of one or more polyamides having a solution viscosity of less than 1.75 (measured in m-cresol solution, 0.5% by wt., 20° C.),
with the above-mentioned indications of % by wt. relating to the total amount of the components (a) to (c), and, relative to 100 parts by wt. of the components (a) to (c), from 0 to 100 parts by weight of one or more additives.

2. Polyamide-elastomer mixture according to claim 1, wherein the elastomer b) is prepared by emulsion polymerization of
b1)≧55% by wt. of at least one conjugated diene,
b2) 5 to 45% by wt. acrylonitrile,
b3) optionally 0 to 5% by wt. of one or more polyfunctional radically polymerizable monomer,
b4) optionally 0 to 20% by wt. of one or more polyfunctional radically polymerizable monomer different from b1) to b3),
with the above-mentioned indications of % by wt. relating to the total amount of the components b1) to b4).

3. Polyamide-elastomer mixture according to claim 1, wherein it contains 0 to 10 parts by wt. of one or more separating agent relative to 100 parts by wt. of the elastomer b).

4. Polyamide-elastomer mixture according to claim 1, wherein the partially crystalline polyamide (a) is selected from the group consisting of the polyamides PA46, PA6, PA66, PA69, PA610, PA612, PA614, PA616, PA618, PA11, PA12, PA1010, PA1012, PA1212, PA MXD6, PA MXD6/MXDI, PA9T, PA10T, PA12T, PA 6T/6I, PA 6T/66, PA 6T/10T, their copolyamides as well as their blends and polyamide block copolymers with soft segments based on polyesters, polyethers, poylsiloxanes or polyolefins, wherein the polyamide content of the polyamide block copolymers is at least 40% by wt, as well as their blends.

5. Polyamide-elastomer mixture according to claim 1, wherein the polyamide (a) has a terminal amino group concentration in the range of from 20 to 120 μeq/g, in particular of from 30 to 100 μeq/g.

6. Polyamide-elastomer mixture according to claim 1, wherein the polyamide (a) has a terminal carboxyl group concentration of maximally 30 μeq/g, in particular of maximally 20 μeq/g.

7. Polyamide-elastomer mixture according to claim 1, wherein the partially crystalline polyamide (a) has a solution viscosity (measured in m-cresol solution, 0.5% by wt., 20° C.) in the range of from 1.75 to 2.4, in particular of from 1.8 to 2.3.

8. Polyamide-elastomer mixture according to claim 2, wherein the conjugated diene (b1) is selected from the group consisting of butadiene, isoprene, 2-chlorobutadiene and 2,3-dichlorobutadiene.

9. Polyamide-elastomer mixture according to claim 2, wherein the radically polymerizable monomer b4) different from b1) to b3) is selected from the group consisting of styrene, esters of acrylic and methacrylic acid, such as ethyl(meth)acrylate, methyl(meth)acrylate, n-propyl(meth)acrylate, n-butyl(meth)acrylate, 2-ethylhexyl(meth)acrylate, as well as hydroxyl-group-containing (meth)acrylates, such as hydroxyethyl(meth)acrylate, hydroxypropyl(meth)acrylate and hydroxybutyl(meth)acrylate, tetrafluoroethylene, vinylidenefluoride, hexafluoropropene, as well as double-bond-containing carboxylic acids, in particular acrylic acid, methacrylic acid, maleic acid, fumaric acid, itaconic acid, amine functionalized (meth)acrylates, such as primary aminoalkyl(meth)acrylic acid esters, such as aminoethyl(meth)acrylate, aminopropyl(meth)acrylate and aminobutyl(meth)acrylate, secondary aminoalkyl(meth)acrylic acid esters, in particular tert-butylamino(C2-C4)alkyl(meth)acrylate, acrolein, N-vinyl-2-pyrrolidone, 2-vinyl-pyridine, 4-vinyl-pyridine, N-allyl-urea and N-allyl-thiourea, (meth)acrylamides, such as (meth)acrylamide, singly or doubly N-substituted (meth)acrylamides and mixtures thereof.

10. Polyamide-elastomer mixture according to claim 2, wherein the polyfunctional radically polymerizable monomer b3) is selected from: di- or polyunsaturated radically polymerizable monomers, in particular compounds with preferably 2 to 4 polymerizable C═C double bonds, such as, in particular, diisopropenylbenzene, divinylbenzene, divinylether, divinylsulfone, diallylphthalate, triallylcyanurate, triallylisocyanurate, 1,2-polybutadiene, N,N′-m-phenylenemaleimide, 2,4-toluoylenebis(maleimide), triallyltrimellitate and polyfunctional acrylates and methacrylates of C₂- to C₁₀-polyalcohols, in particular ethylene glycol, propanediol-1,2, butanediol-1,4, hexanediol, polyethylene glycol with 2 to 20, in particular 2 to 8 oxyethylene units, neopentyl glycol, bisphenol-A, glycerin, trimethylolpropane, pentaerythritol, sorbitol with unsaturated polyesters from aliphatic di- and polyols and mixtures thereof.

11. Polyamide-elastomer mixture according to claim 10, wherein the polyfunctional radically polymerizable monomer (b3) is selected from divinylbenzene, trimethylolpropane trimethacrylate, trimethylolpropane triacrylate, ethylene glycol dimethacrylate, ethylene glycol diacrylate, butanediol-1,4-di(meth)acrylate and mixtures thereof.

12. Polyamide-elastomer mixture according to claim 2, wherein the elastomer b) is obtained by cross-linking subsequent to the emulsion polymerization in the presence of one or more radical initiators, selected from the group consisting of: organic peroxides, in particular dicumylperoxide, t-butylcumylperoxide, bis-(t-butylperoxy-isopropyl)benzene, di-t-butylperoxide, 2,5-dimethylhexane-2,5-dihydroperoxide, 2,5-dimethylhexine-3,2,5-dihydroperoxide, dibenzoylperoxide, bis-(2,4-dichlorobenzoyl)peroxide, t-butylperbenzoate as well as organic azo compounds, in particular azo-bis-isobutyronitrile and azo-bis-cyclohexanenitrile and di- and polymercapto-compounds, in particular dimercaptoethane, 1,6-dimercaptohexane, 1,3,5-trimercaptotriazine and mercapto-terminated polysulfide rubbers, in particular mercapto-terminated reaction products of bis-chloroethylformal with sodium polysulfide.

13. Polyamide-elastomer mixture according to claim 2, wherein the elastomer b) is obtained without adding a polyfunctional radically polymerizable monomer b3) by polymerization at temperatures of ≧10° C. and polymerization at conversion values ≧70 mol-%, relative to the total amount of the monomer mixture used.

14. Polyamide-elastomer mixture according to claim 3, wherein the separating agent is selected from the group consisting of: inorganic and organic separating agents, such as silicic acids, in particular with a specific surface area according to BET of more than 5 m²/g, calcium carbonate, magnesium carbonate, silicates, such as talcum and mica, fatty acid salts, such as, in particular, alkaline and alkaline earth salts, such as salts of fatty acids with more than 10 carbon atoms, such as, in particular, calcium and magnesium salts of such fatty acids, such as calcium stearate, magnesium stearate and aluminum zinc stearate, calcium phosphate, aluminum oxide, barium sulfate, zinc oxide, titanium dioxide, polymers with a high glass transition temperature of, for example, more than 60° C., such as polyesters, polyolefines and starch, hydrophilic polymers, such as polyvinyl alcohol, polyalkyleneoxide compounds, in particular polyethyleneoxide compounds, such as polyethylene glycols or polyethylene glycolethers, polyacrylic acid, polyvinylpyrrolidone and cellulose derivatives, fluorocarbons.

15. Polyamide-elastomer mixture according to claim 2, wherein the amount of acrylonitrile b2) in the elastomer b) is in the range of from 10 to 40% by wt., particularly in the range of from 28 to 35% by wt., relative to the amount of the components b1) to b3).

16. Polyamide-elastomer mixture according to claim 1, wherein 5 to 40% by wt., in particular 10 to 30% by wt., of the elastomer (b) are contained therein.

17. Polyamide-elastomer mixture according to claim 1, wherein the polyamide (c) has a solution viscosity (measured in m-cresol solution, 0.5% by wt., 20° C.) in the range of from 1.4 to less than 1.75, in particular of from 1.5 to 1.7.

18. Polyamide-elastomer mixture according to claim 1, wherein the polyamide (c) is a lactam-free polyamide.

19. Polyamide-elastomer mixture according to claim 1, wherein the polyamide (c) is an amorphous or polycrystalline polyamide.

20. Polyamide-elastomer mixture according to claim 1, wherein the polyamide (c) is selected from the group of polyamides, comprising aliphatic, cycloaliphatic or aromatic diamines, dicarboxylic acids and/or aminocarboxylic acids, in particular with 6 to 36 carbon atoms and mixtures of such homopolyamides and/or copolyamides.

21. Polyamide-elastomer mixture according to claim 1, wherein the polyamide (c) is selected from the group consisting of MACM12, MACM13, MACM14, MACM16, MACM18, PACM12, PACM13, PACM14, PACM16, PACM18 of the copolyamides MACM12/PACM12, MACM13/PACM13, MACM14/PACM14, MACM16/PACM16, MACM18/PACM18 and mixtures of such polyamides.

22. Polyamide-elastomer mixture according to claim 1, wherein the polyamide (c) has a glass transition temperature of greater than or equal to 110° C., preferably greater than or equal top 130° C., and particularly preferably greater than or equal to 150° C.

23. Polyamide-elastomer mixture according to claim 1, wherein the polyamide-elastomer mixture has an MVR (melt volume rate), at 275° C. and a load of 21.6 kg, in the range of from 50 to 200 cm³/10 min (DIN ISO 1133: 1991).

24. Polyamide-elastomer mixture according to claim 1, wherein a molded article obtainable from the polyamide-elastomer mixture has a residual elongation at break of at least 20% of the initial value after storage of tensile test rods in a water/glycol (60:40) mixture at 135° C. and a storage time of 500 h.

25. Molded article obtainable from a polyamide-elastomer mixture according to claim 1.

26. Molded article according to claim 25, wherein the molded article has a residual elongation at break of at least 20% of the initial value after storage in tensile impact test rods in a water/glycol (60:40) mixture at 135° C. and a storage time of 500 h.

27. Molded article according to claim 25, wherein the molded article has an elongation at break in the dry condition of at least 150%.

28. Molded article according to claim 25, wherein the molded article has a tensile modulus in ISO test rods in the dry condition in the range of from 300 to 1500 MPa.

29. Molded article according to claim 25, wherein the molded article has a notch impact strength of at least 10 kJ/m² at −30° C., measured with ISO test rods.

30. Molded article according to claim 25, wherein the molded article exhibits oils swelling in IRM 903 according to 4d at a temperature of 125° C. of maximally 3%.

31. Molded article according to claim 25, in the form or a crankcase or in the form of smooth, corrugated or partially corrugated mono- or multilayer pipes, e.g. cooling liquid pipes.

32. Method for producing molded articles in the automobile industry that are in contact with liquid media containing water, oil, glycol, methanol, ethanol and/or fuel comprising the step of using the polyamide elastomer mixture according to claim 1.

33. Method according to claim 32, comprising the step of producing ventilation systems for crankcases, mono- and multilayer pipes in the negative as well as the positive pressure range, cooling liquid pipes as well as oil-conducting pipes or pipes in contact with oil.

34. Method producing polyamide-containing compositions comprising the step of using acrylonitrile-containing elastomers produced by the steps of emulsion polymerization, and
subsequent spray drying of the latex obtained during emulsion polymerization.
